(19) United States
(12) Patent Application Publication
(10) Pub. No.: US 2011/0035667 A1
(43) Pub. Date: Feb. 10, 2011

(54) Instant Import of Media Files

(76) Inventor: Bjorn Michael Dittmer-Roche, Brooklyn, NY (US)

Correspondence Address: Bjorn Michael Dittmer Roche, POBox 8537, New York, NY, 10016-8537, US

(21) Appl. No.: 12/535,693

(22) Filed: Aug. 5, 2009

(51) Int. Cl. G06F 3/01; G06F 17/30

(52) U.S. Cl. 715/716; 707/E17.009

(57) ABSTRACT

A request to import a media file is received, and a first piece of meta information associated with the media file is read. A user may then edit a representation of the media file while at least one background task is performed to complete the import of the media file. After performing the at least one background task, enhanced editing functionality is provided.

### BACKGROUND

Current digital audio software (e.g., digital audio workstations or digital audio sequencers) typically incorporates new audio in one of two ways: 1) by recording it directly from an audio device, such as a sound card attached to the computer (or other hardware device, if the audio software is not executed on a computer); or 2) by incorporating audio files produced by other software or hardware. This second method, commonly called “importing,” may take substantial time and computing resources because the audio file is first read to determine certain stored meta information associated with the file, such as the number of channels and the file format, and then the audio file may be scanned to create or determine other meta information that does not exist or is not stored in a convenient manner in most file formats. This additional meta information is typically required in order for the software to take full advantage of the file.

Although some effort has been made by audio software developers to incorporate a wide variety of meta information into the audio files themselves, so that this meta information can be read quickly and conveniently, these efforts have not been widely embraced. As a result, the process of importing audio and other media files is often time-consuming and requires an interruption to a user's workflow while waiting for meta information to be read and prepared. Even if more meta information were stored with media files, the software storing the meta information would be unable to predict the types of meta information that might be required by a subsequent user. Indeed, old recordings and recordings produced by non-professional digital audio software would still lack the required meta information. Thus, importing media files is likely to remain a time-consuming step.

It would therefore be desirable to improve the import process for media files.

### BRIEF SUMMARY

In one embodiment, a computer-implemented method for importing media files is described, the method comprising: receiving a request to import a media file; reading a first piece of meta information associated with the media file; enabling a user to edit a representation of the media file after reading the first piece of meta information; performing at least one background task to complete the import of the media file, while enabling the user to edit the representation of the media file; and providing enhanced editing functionality after performing the at least one background task.

In yet another embodiment, an audio system for editing audio files comprises: a processor that executes instructions; and a computer-readable memory that stores instructions that cause the processor, upon receiving a request to import an audio file, to enable editing by: reading a first piece of meta information associated with the audio file; enabling a user to edit a representation of the audio file after reading the first piece of meta information; performing at least one background task to complete the import of the audio file, while enabling the user to edit the representation of the audio file; and providing enhanced editing functionality after performing the at least one background task.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of an audio system for editing audio files, according to one illustrated embodiment.

FIG. 2 is a flow diagram illustrating a method for importing media files, according to one illustrated embodiment.

FIG. 3 is a screen shot from a program that enables a user to edit a representation of a media file after reading a first piece of meta information, according to one illustrated embodiment.

FIG. 4 is another screen shot from the program of FIG. 3 providing enhanced editing functionality after performing at least one background task, according to one illustrated embodiment.

### DETAILED DESCRIPTION OF EMBODIMENTS OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, etc. In other instances, well-known structures and methods associated with audio devices, digital audio workstations and computing devices have not been shown or described in detail to avoid unnecessarily obscuring descriptions of the embodiments.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the embodiments.

### Description of an Example Audio System

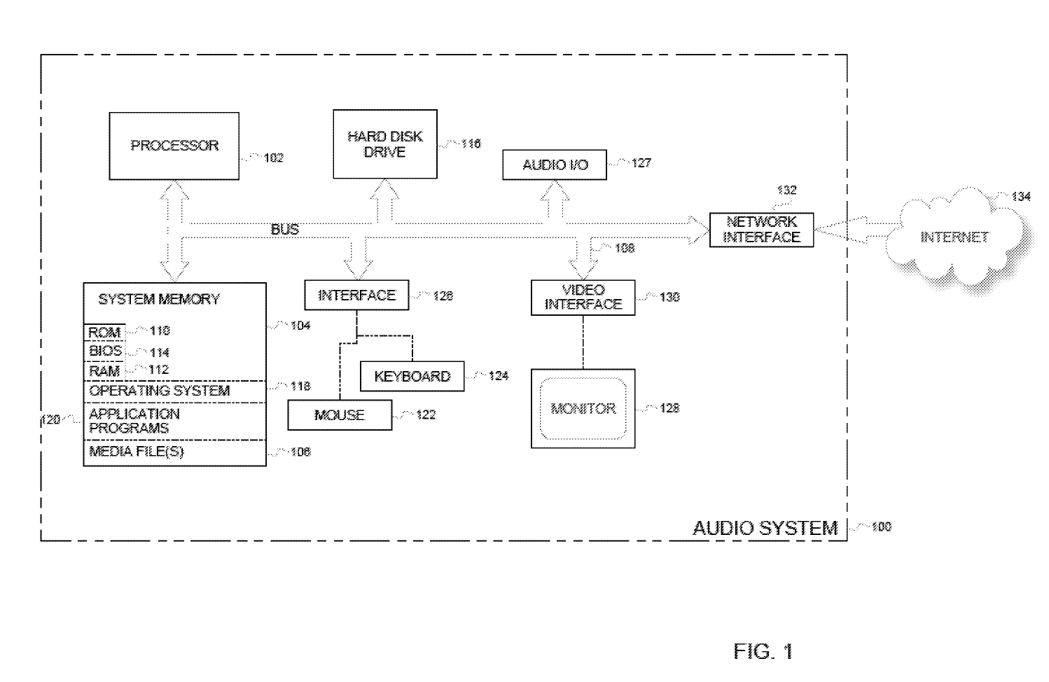

FIG. 1 and the following discussion provide a brief, general description of an audio system 100 configured for importing and editing media files, such as audio files. While described in the context of an audio system 100, it may be understood that the same hardware described in detail herein may also be used to import and edit other types of media files, such as video or audio/video files. Although not required, the embodiments will be described in the general context of computer-executable instructions, such as program application modules, objects, or macros being executed by a computer. Those skilled in the relevant art will appreciate that the illustrated embodiments as well as other embodiments can be practiced with other computer system configurations, including digital audio and/or video editing hardware, handheld devices, multiprocessor systems, microprocessor-based or programmable consumer electronics, personal computers (“PCs”), network PCs, embedded systems, “set top boxes,” and the like. The embodiments can be practiced in distributed computing environments where tasks or modules are performed by remote processing devices, which are linked through a communications network. In a distributed computing environment, program modules may be located in both local and remote memory storage devices.

FIG. 1 shows an audio system 100, which comprises a computer. As illustrated, the audio system 100 may include a processor 102 that executes instructions, and a computer-readable system memory 104 that stores instructions that cause the processor 102, upon receiving a request to import a media file 106 (e.g., an audio file), to enable editing by: reading a first piece of meta information associated with the media file 106; enabling a user to view or edit a representation of the media file 106 after reading the first piece of meta information; performing at least one background task to complete the import of the media file 106, while enabling the user to edit the representation of the media file 106; and providing enhanced editing functionality after performing the at least one background task. The audio system 100 and this method for importing a media file 106 will be described in greater detail below.

The audio system 100 may take the form of a conventional PC, which includes the processor 102, the system memory 104 and a system bus 108 that couples various system components including the system memory 104 to the processing unit 102. The audio system 100 will at times be referred to in the singular herein, but this is not intended to limit the embodiments to a single computing device, since in certain embodiments, there will be more than one networked computing device involved.

The processor 102 may be any logic processing unit, such as one or more central processing units (CPUs), digital signal processors (DSPs), application-specific integrated circuits (ASICs), field programmable gate arrays (FPGAs), etc. Unless described otherwise, the construction and operation of the various blocks shown in FIG. 1 are of conventional design. As a result, such blocks need not be described in further detail herein, as they will be understood by those skilled in the relevant art.

The system bus 108 can employ any known bus structures or architectures, including a memory bus with memory controller, a peripheral bus, and a local bus. The system memory 104 includes read-only memory (“ROM”) 110 and random access memory (“RAM”) 112. A basic input/output system (“BIOS”) 114, which can form part of the ROM 110, contains basic routines that may help transfer information between elements within the audio system 100 (e.g., during start-up).

The audio system 100 also includes a hard disk drive 116 for reading from and writing to a hard disk. Though not shown, the audio system 100 may further or alternatively include other storage devices, such as an optical disk drive and/or a flash-based storage device. The hard disk drive 116 communicates with the processor 102 via the system bus 108. The hard disk drive 116 may include interfaces or controllers (not shown) coupled between the hard disk drive 116 and the system bus 108. The hard disk drive 116, and its associated computer-readable media may provide nonvolatile storage of computer-readable instructions, media files 106, program modules and other data for the audio system 100.

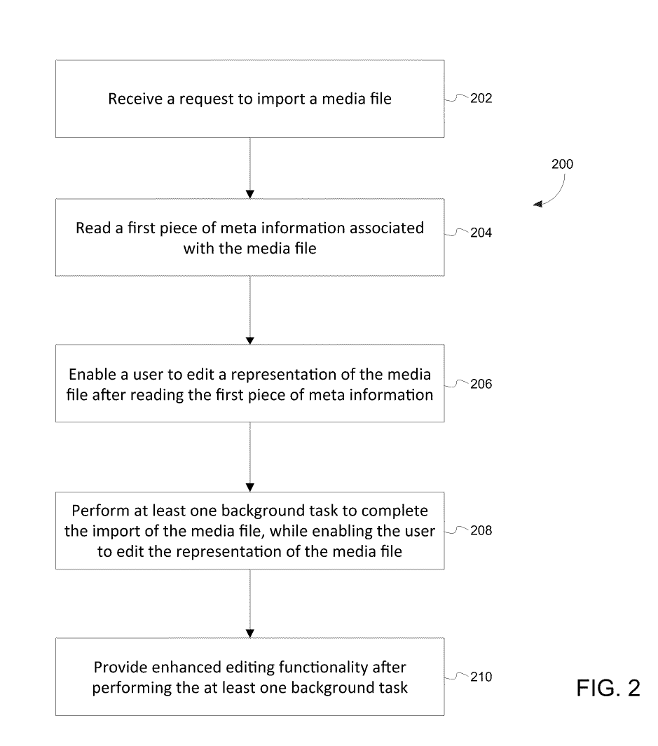

A variety of program modules can be stored in the system memory 104, including an operating system 118, one or more application programs 120, and at least one media file 106. In one embodiment, at least one of the application programs 120 may enable the importation and editing of at least one media file 106. In such an embodiment, this application program 120 may provide much of the functionality described below with reference to FIG. 2. While shown in FIG. 1 as being stored in the system memory 104, the operating system 118, application programs 120, and at least one media file 106 can be stored in a nonvolatile storage device, such as the hard disk drive 116.

A user can enter commands and information into the audio system 100 using a mouse 122 and/or a keyboard 124. Other input devices can include a microphone, other musical instruments, scanner, etc. In one embodiment, one or more of these input devices may be used in order to interact with and edit the media files 106. These and other input devices are connected to the processor 102 through an interface 126 such as a universal serial bus (“USB”) interface that couples to the system bus 108, although other interfaces such as another serial port, a game port or a wireless interface may also be used. The audio system 100 may further include an audio I/O interface 127, such as a sound card. The audio I/O 127 may enable a user to import audio from an external source, and/or play audio on one or more speakers. A monitor 128 or other display device may be coupled to the system bus 108 via a video interface 130, such as a video adapter. Although not shown, the audio system 100 can include other output devices, such as printers.

In one embodiment, the audio system 100 operates in a networked environment using one or more logical connections to communicate with one or more remote computers or other computing devices. These logical connections may facilitate any known method of permitting computers to communicate, such as through one or more LANs and/or WANs, such as the Internet 134. In one embodiment, a network interface 132 (communicatively linked to the system bus 108) may be used for establishing communications over the logical connection to the Internet 134. In a networked environment, program modules, application programs, or media files, or portions thereof, can be stored outside of the audio system 100 (not shown). Those skilled in the relevant art will recognize that the network connections shown in FIG. 1 are only some examples of ways of establishing communications between computers, and other connections may be used.

### Discussion of a Method for Importing Media Files According to One Embodiment

FIG. 2 illustrates a flow diagram for a method 200 of importing media files, according to one embodiment. This method 200 will be discussed in the context of an application program executing on the audio system 100 illustrated in FIG. 1. However, it may be understood that the acts disclosed herein may also be executed in different software or hardware-based workstations used to work with a variety of media files in accordance with the described method.

The method begins at act 202, when a request is received to import a media file 106. The media file 106 may comprise any of a variety of media files, including audio files, audio/video files, video files, graphics files, etc. The media file 106 may also be stored in any of a variety of formats (e.g., Sound Designer II, WAV, BWV or AIFF). The media file 106 may be locally stored (as illustrated in FIG. 1) in a hard disk drive 116 or on another non-volatile storage device associated with the audio system 100. In another embodiment, the media file 106 may be remotely stored and may be accessed via a network connection (e.g., via the Internet 134).

In one embodiment, the request to import the media file 106 is received by an application program 120 executing on the audio system 100, such as media editing software. For example, a request to import an audio file may be received by digital audio editing software. As used herein, the term “import” refers to any act of loading at least a portion of the media file 106 for editing by the audio system 100. In many embodiments, at least a portion of the data or metadata stored in the media file 106 is placed in the system memory 104 to facilitate editing.

The request to import the media file 106 may be initiated by a user interacting with the audio system 100. The user may initiate the request by accessing menu commands in a user interface of an application program 120, commands such as “Open”, “Load”, “Import”, etc. In one embodiment, the user may view a plurality of media files 106 on the monitor 128 and may select the media file 106 for importation using a keyboard 124 or mouse 122 or other input device. In other embodiments, the request to import the media file 106 may be automatically generated by a script or another program module.

In some embodiments, the process of importing the media file 106 may include a variety of ancillary actions. In one embodiment, receiving the request to import the media file 106 may include receiving a request to move or copy the media file 106. For example, the media file 106 may be stored remotely, and the request to import the media file 106 may include a request to move or copy the media file 106 from the remote storage location to a local storage device, such as the hard disk drive 116. In another embodiment, receiving the request to import the media file 106 may include receiving a request to convert the media file 106 from a first format to a second format. This second format may enable additional editing functionality or increased processing speed.

At 204, a first piece of meta information associated with the media file 106 is read. Different media files may have stored therewith a variety of meta information. As used herein, the term “meta information” refers to any information that characterizes the content of a media file. As a subset of meta information, the term “metadata” is used to refer to information stored with a media file that characterizes the content of the media file. Metadata may be stored with the media file 106 as embedded information, or in a separate file associated with the media file 106. For example, channel and format information is frequently stored with most popular pro audio file formats as metadata, and this meta information can be read very quickly.

In one embodiment, all of the meta information stored as metadata is read at act 204. In another embodiment, one or more pieces of meta information (which may or may not be stored as metadata) may be read at act 204 in order to support a limited set of editing tasks.

At 206, a user is enabled to edit a representation of the media file 106 after reading the first piece of meta information. In one embodiment, the user may interact with a user interface generated by an application program 120 executing on the audio system 100 in order to edit the representation of the media file 106. For example, a textual or graphical representation of the media file 106 may be displayed on the monitor 128, and the user may interact with one or more menus or execute keyboard commands by manipulating the mouse 122 and/or keyboard 124 in order to effect edits.

A variety of editing functionality may be enabled after reading the first piece of meta information. The audio system 100 may thus be configured to allow a user to edit the representation of the media file 106 without completing an import process and processing all of the meta information that the audio system 100 might gather. The editing tasks enabled by the audio system 100 may include, inter alia: destructive and non-destructive copying, pasting, cutting, “trimming” or “cropping,” moving, applying effects, looping sections, etc. In one embodiment, these editing tasks may represent a subset of the editing functionality enabled after completing the import of the media file 106. However, this partial editing functionality may offer a user a more continuous work experience.

At 208, at least one background task is performed to complete the import of the media file 106, while enabling the user to edit the representation of the media file 106. In one embodiment, the at least one background task may include processing metadata associated and stored with the media file 106 in order to determine additional meta information. In another embodiment, the at least one background task may include scanning the media file to determine a second piece of meta information. For example, the media file 106 may be scanned to produce a media file overview. The media file overview may comprise a chart showing the volume at different times in the media file 106. In an embodiment in which the media file 106 is a video file, the media file overview may include video thumbnails, and the at least one background task may include building the video thumbnails. The media file overview may then be used during editing operations. As another example, the media file 106 may be scanned to determine a peak amplitude associated with the media file 106. In another embodiment, the at least one background task may include moving or copying the media file 106 to create a second media file (the moved/copied version). In yet another embodiment, the at least one background task may include converting the media file 106 from a first format to a second format. The at least one background task may further include more than one of the above activities or additional tasks.

Although called “background” tasks, it may be understood that the at least one background task may be performed at any of a variety of priority levels by the audio system 100. In one embodiment, the at least one background task is performed in the background of a multi-tasking operating system 118. In another embodiment, the at least one background task is performed as a process in a primitive, non-preemptive operating system. In some embodiments, the at least one background task may be set to a relatively low priority, such that normal operations of the audio system 100 (and, in particular, editing tasks related to the media file 106) are substantially unimpaired.

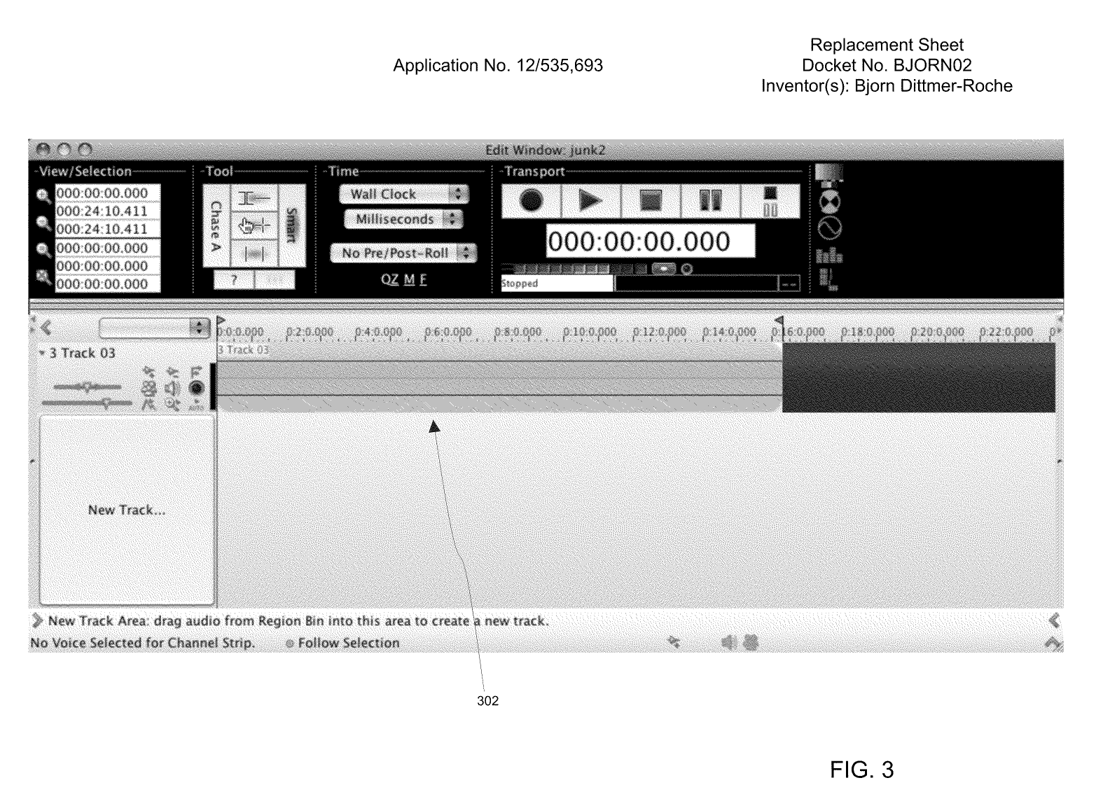

While the at least one background task is being performed, the user may continue to have the ability to edit the representation of the media file 106. Thus, although the user's editing capabilities may be limited before the import of the media file 106 has been completed, the user may still edit and interact with a representation of the media file 106 during the import process. In one embodiment, as illustrated in FIG. 3, while the media file 106 is being imported (and at least one background task is being performed), the user may interact with a representation 302 of the media file 106 without media file overview information. As illustrated, the representation 302 may provide relatively limited information (e.g., total clip length) about the media file 106. Thus, the user may perform some limited editing tasks, such as moving, before the media file 106 has been completely imported.

In one embodiment, while the media file 106 is being copied or moved, the user may be able to edit a representation of the original media file 106. In another embodiment, while the media file 106 is being converted from a first format to a second format, the user may be able to edit a representation of the media file 106 in the first format.

At 210, enhanced editing functionality is provided after performing the at least one background task. Any of a variety of enhanced editing functionality may be enabled after performing the at least one background task. For example, in one embodiment, after the media file 106 has been copied or moved to create a second media file, then user interaction may be enabled with a representation of the second media file.

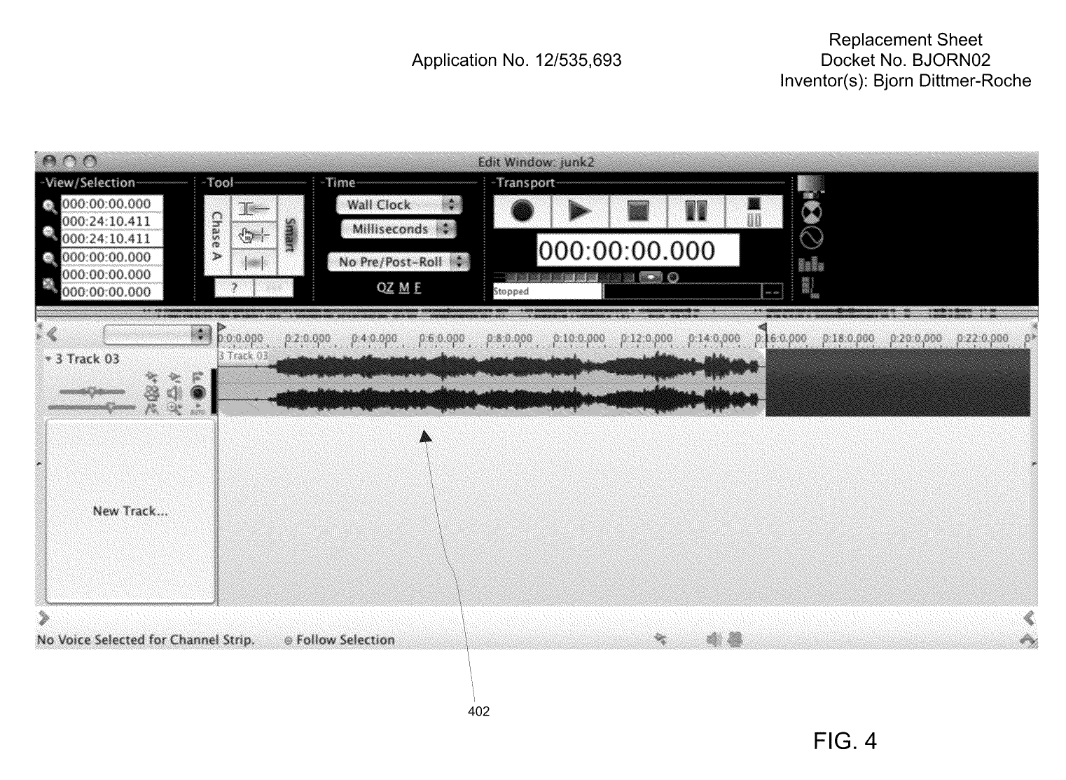

In another embodiment, after scanning the media file 106 to produce a media file overview, the media file overview 402 may be presented to the user (e.g., on the monitor 128) to facilitate editing tasks, as illustrated in FIG. 4. In another embodiment, portions of the media file overview may be presented to the user even before the scanning of the media file 106 is completed. These chunks of media file overview data may thus give a user gradually increased editing functionality as the at least one background task is competed.

In another embodiment, after converting the media file 106 from a first format to a second format, the user may be enabled to edit a representation of the media file 106 in the second format. This may be advantageous, for example, if the audio system 100 can work with a compressed format (e.g., FLAC format), but prefers an uncompressed format (e.g., AIFF format) because the compressed format is harder to edit and uses too much CPU time to decode during playback. After the conversion, an application program can switch to the media file 106 in the uncompressed format and thus allow improved editing and playback performance. Similarly, a video system may receive a request to import an MPEG file, which it may be able to work with, but the video system may prefer another format, such as h.264. The video system can therefore work with the MPEG file until the MPEG file has been converted into the preferred format and then switch to the converted file for improved performance.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more programs executed by one or more processors, as one or more programs executed by one or more controllers (e.g., microcontrollers), as firmware, or as virtually any combination thereof, and that designing the circuitry and/or writing the code for the software and or firmware would be well within the skill of one of ordinary skill in the art in light of this disclosure.

When logic is implemented as software and stored in memory, one skilled in the art will appreciate that logic or information can be stored on any computer readable medium for use by or in connection with any processor-related system or method. In the context of this document, a memory is a computer readable medium that is an electronic, magnetic, optical, or other physical device or means that contains or stores a computer and/or processor program. Logic and/or the information can be embodied in any computer readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer readable medium” can be any means that can store, communicate, propagate, or transport the program associated with logic and/or information for use by or in connection with the instruction execution system, apparatus, and/or device. The computer readable medium can be, for example, but is not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). Note that the computer-readable medium could even be paper or another suitable medium upon which the program associated with logic and/or information is printed, as the program can be electronically captured, via for instance optical scanning of the paper or other medium, then compiled, interpreted or otherwise processed in a suitable manner if necessary, and then stored in memory.

The various embodiments described above can be combined to provide further embodiments. From the foregoing it will be appreciated that, although specific embodiments have been described herein for purposes of illustration, various modifications may be made without deviating from the spirit and scope of the teachings. Accordingly, the claims are not limited by the disclosed embodiments.

We/I claim:

1. A computer-implemented method for importing media files, the method comprising:
receiving a request to import a media file;
reading a first piece of meta information associated with the media file;
enabling a user to edit a representation of the media file after reading the first piece of meta information;
performing at least one background task to complete the import of the media file, while enabling the user to edit the representation of the media file; and
providing enhanced editing functionality after performing the at least one background task.

2. The method of claim 1, wherein the media file is one of an audio file or an audio/video file.

3. The method of claim 1, wherein receiving the request to import the media file includes receiving a request to move or copy the media file.

4. The method of claim 3, wherein performing the at least one background task includes moving or copying the media file to create a second media file, and providing the enhanced editing functionality includes enabling interaction with a representation of the second media file.

5. The method of claim 1, wherein performing the at least one background task includes scanning the media file to determine a second piece of meta information.

6. The method of claim 5, wherein scanning the media file to determine the second piece of meta information includes scanning the media file to produce a media file overview.

7. The method of claim 6, wherein scanning the media file to produce the media file overview includes building video thumbnails comprising the media file overview.

8. The method of claim 6, wherein providing the enhanced editing functionality includes presenting the media file overview to the user for editing tasks.

9. The method of claim 8, further comprising presenting portions of the media file overview before completing the scanning of the media file.

10. The method of claim 5, wherein scanning the media file to determine the second piece of meta information includes scanning the media file to determine a peak amplitude.

11. The method of claim 1, wherein performing the at least one background task includes converting the media file from a first format to a second format.

12. The method of claim 11, wherein enabling the user to edit the representation of the media file includes enabling the user to edit the representation of the media file in the first format and providing the enhanced editing functionality includes enabling the user to edit a representation of the media file in the second format.

13. An audio system for editing audio files, comprising:
a processor that executes instructions; and
a computer-readable memory that stores instructions that cause the processor, upon receiving a request to import an audio file, to enable editing by:
reading a first piece of meta information associated with the audio file;
enabling a user to edit a representation of the audio file after reading the first piece of meta information;
performing at least one background task to complete the import of the audio file, while enabling the user to edit the representation of the audio file; and
providing enhanced editing functionality after performing the at least one background task.

14. The audio system of claim 13, wherein receiving the request to import the audio file includes receiving a request to move or copy the audio file.

15. The audio system of claim 14, wherein performing the at least one background task includes moving or copying the audio file to create a second audio file, and providing the enhanced editing functionality includes enabling interaction with a representation of the second audio file.

16. The audio system of claim 13, wherein performing the at least one background task includes scanning the audio file to determine a second piece of meta information.

17. The audio system of claim 16, wherein scanning the audio file to determine the second piece of meta information includes scanning the audio file to produce an audio file overview.

18. The audio system of claim 17, wherein providing the enhanced editing functionality includes presenting the audio file overview to the user for editing tasks.

19. The audio system of claim 13, wherein performing the at least one background task includes converting the audio file from a first format to a second format.

20. A computer-readable medium that stores instructions that cause a processor to import media files, by:
receiving a request to import a media file;
reading a first piece of meta information associated with the media file;
enabling a user to edit a representation of the media file after reading the first piece of meta information;
performing at least one background task to complete the import of the media file, while enabling the user to edit the representation of the media file; and
providing enhanced editing functionality after performing the at least one background task.
